(19) United States
(12) Patent Application Publication
(10) Pub. No.: US 2003/0174125 A1
(43) Pub. Date: Sep. 18, 2003

(54) Multiple input modes in overlapping physical space

(76) Inventors: Ilhami Torunoglu, Monte Sereno, CA (US); Apurva Desai, Fremont, CA (US); Cheng-Feng Sze, Cupertino, CA (US); Gagan Prakash, Santa Clara, CA (US); Abbas Rafii, Palo Alto, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/367,609

(22) Filed: Feb. 13, 2003

Related U.S. Application Data
(63) Continuation-in-part of application No. 10/313,939, filed on Dec. 5, 2002.
(63) Continuation-in-part of application No. 09/502,499, filed on Feb. 11, 2000.
(60) Provisional application No. 60/357,735, filed on Feb. 15, 2002.
(60) Provisional application No. 60/339,234, filed on Dec. 7, 2001.
(60) Provisional application No. 60/163,445, filed on Nov. 4, 1999.
(60) Provisional application No. 60/231,184, filed on Sep. 7, 2000.
(60) Provisional application No. 60/382,899, filed on May 22, 2002.
(60) Provisional application No. 60/382,899, filed on May 22, 2002.
(60) Provisional application No. 60/281,314, filed on Apr. 3, 2001.
(60) Provisional application No. 60/337,086, filed on Nov. 27, 2001.
(60) Provisional application No. 60/300,542, filed on Jun. 22, 2001.

(51) Int. Cl. G09G 5/00

(52) U.S. Cl. 345/168

(57) ABSTRACT

In a sensory input system that detects movement of a user's fingers on an inert work surface, two or more input modes (for instance, keyboard and mouse) are provided within an overlapping or coextensive physical space. Depending on the currently active mode, the invention interprets the finger motions as input according to one of the input modes. Automated and/or manual mode-switching are provided.

### CROSS-REFERENCE TO RELATED APPLICATIONS

This application claims priority from U.S. provisional patent application Serial No. 60/357,735 for “Method and Apparatus for Accomplishing Two or More Input Methods in the Same Physical Space Using a Sensory Input System,” filed Feb. 15, 2002, the disclosure of which is incorporated herein by reference.

The present application is a continuation-in-part of U.S. patent application Ser. No. 10/313,939 for “Portable Sensory Input Device,” filed Dec. 5, 2002, the disclosure of which is incorporated herein by reference, and which in turn claims priority from U.S. Provisional Patent Application Serial No. 60/339,234 for “Method and Apparatus for Stability and Alignment of a Portable Sensory Input Device,” filed Dec. 7, 2001, and which in turn is a continuation-in-part of the following U.S. patent applications, the disclosures of which are incorporated herein by reference:

U.S. patent application Ser. No. 09/502,499 for “Method and Apparatus for Entering Data Using a Virtual Input Device,” filed Feb. 11, 2000, which in turn claims priority from U.S. Provisional Patent Application Serial No. 60/163,445 for “Method and Device for 3D Sensing of Input Commands to Electronic Devices,” filed Nov. 4, 1999.

U.S. patent application Ser. No. 09/948,508 for “Quasi-Three-Dimensional Method and Apparatus To Detect and Localize Interaction of User-Object and Virtual Transfer Device,” filed Sep. 7, 2001, which in turn claims priority from U.S. Provisional Patent Application Ser. No. 60/231,184 for “Application of Image Processing Techniques for A Virtual Keyboard System,” filed Sep. 7, 2000.

U.S. patent application Ser. No. 10/245,925 for “Measurement of Depth from Thickness or Separation of Structured Light with Application to Virtual Interface Devices,” filed Sep. 17, 2002, which in turn claims priority from U.S. Provisional Patent Application Serial No. 60/382,899 for “Measurement of Distance in a Plane from the thickness of a Light Beam from the Separation of Several Light Beams,” filed May 22, 2002.

U.S. patent application Ser. No. 10/246,123 for “Method and Apparatus for Approximating Depth of an Object's Placement into a Monitored Region with Applications to Virtual Interface Devices,” filed Sep. 17, 2002, which in turn claims priority from U.S. Provisional Patent Application Serial No. 60/382,899 for “Measurement of Distance in a Plane from the thickness of a Light Beam from the Separation of Several Light Beams,” filed May 22, 2002.

U.S. patent application Ser. No. 10/115,357 for “Method and Apparatus for Approximating a Source Position of a Sound-Causing Event for Determining an Input Used in Operating an Electronic Device,” filed Apr. 2, 2002, which in turn claims priority from U.S. Provisional Patent Application Serial No. 60/281,314 for “A Localization System Based on Sound Delays,” filed Apr. 3, 2001.

U.S. patent application Ser. No. 10/187,032 for “Detecting, Classifying, and Interpreting Input Events Based on Stimuli in Multiple Sensory Domains,” filed Jun. 28, 2002, which in turn claims priority from U.S. Provisional Patent Application Serial No. 60/337,086 for “Sound-Based Method and Apparatus for Detecting the Occurrence and Force of Keystrokes in Virtual Keyboard Applications,” filed Nov. 27, 2001.

U.S. patent application Ser. No. 10/179,452 for “Method and Apparatus to Display a Virtual Input Device,” filed Jun. 24, 2002, which in turn claims priority from U.S. Provisional Patent Application Serial No. 60/300,542 for “User Interface Projection System,” filed Jun. 22, 2001.

### BACKGROUND OF THE INVENTION

1. Field of the Invention

The present invention relates to input devices for portable electronic devices, and more particularly to an input device that accommodates multiple input modes in the same physical space.

2. Description of the Background Art

In a virtual keyboard system, a user taps on regions of a surface with his or her fingers or with another object such as a stylus, in order to interact with an electronic device into which data is to be entered. The system determines when a user's fingers or stylus contact a surface having images of keys (“virtual keys”), and further determines which fingers contact which virtual keys thereon, so as to provide input to a PDA (or other device) as though it were conventional keyboard input. The keyboard is virtual, in the sense that no physical device need be present on the part of surface that the user contacts, henceforth called the work surface.

A virtual keyboard can be implemented using, for example, a keyboard guide: a piece of paper or other material that unfolds to the size of a typical keyboard, with keys printed thereon to guide the user's hands. The physical medium on which the keyboard guide is printed is simply an inert surface and has no sensors or mechanical or electronic component. The input to the PDA (or other device) does not come from the keyboard guide itself, but rather is based on detecting contact of the user's fingers with areas on the keyboard guide. Alternatively, a virtual keyboard can be implemented without a keyboard guide, so that the movements of a user's fingers on any surface, even a plain desktop, are detected and interpreted as keyboard input. Alternatively, an image of a keyboard may be projected or otherwise drawn on any surface (such as a desktop) that is defined as the work surface or active area, so as to provide finger placement guidance to the user. Alternatively, a computer screen or other display may show a keyboard layout with icons that represent the user's fingers superimposed on it. In some applications, nothing is projected or drawn on the surface.

U.S. Pat. No. 6,323,942, for “CMOS Compatible 3-D Image Sensor,” the disclosure of which is incorporated herein by reference, discloses a three-dimensional imaging system including a two-dimensional array of pixel light sensing detectors and dedicated electronics and associated processing circuitry to measure distance and velocity data in real time using time-of-flight (TOF) data.

The related patent applications referenced above disclose additional data input methods, modes, and apparatuses including direct three-dimensional sensing, planar range sensors, and vertical triangulation. Such techniques detect user input by sensing three-dimensional data to localize the user's fingers as they come in contact with a surface.

The applications further describe several data input methods, modes, and apparatuses for sensing object movements with a sensing device (either 3D, planar, vertical triangulation, or otherwise) and interpreting such movements into digital data (such as keystrokes). In some of the above applications, techniques are described for combining stimuli detected in two or more sensory domains in order to improve performance and reliability in classifying and interpreting user gestures. These data input methods are used for entering data into any kind of electronic equipment such as mobile devices (e.g. PDA, cell-phone, pen-tablet, computer, etc.) and provide significant benefits over existing methods due to their ease of use, portability, speed of data entry, power consumption, weight, and novelty. Many of the described techniques are implemented in a virtual keyboard input system in which a user may strike an inert surface, such as a desktop, on which a keyboard pattern is being projected.

The Senseboard product, offered by Senseboard Technologies AB of Stockholm, Sweden, captures and interprets the motion of a user's fingers in order to allow keyboard-like input without a physical keyboard.

Conventional sensing devices are typically adapted to detect one particular type of input in a particular defined area, such as for example keyboard input. However, in many situations if it is desirable to provide two or more input modes. For example, most personal computers now provide both mouse and keyboard input devices, both of which are often used in quick succession to provide input and to specify command and control functions. Conventional sensing devices that operate by detecting finger motion are unable to perform both input functions in a given detection area.

MultiTouch products offered by FingerWorks Inc. of Townsend, Del. provide limited capability for receiving typing, mouse, and gesture input in the same overlapping area of an input pad. These products use an input detection pad and are not able to function on an inert surface such as an ordinary desktop. The overall input area is limited to that covered by the active surface, thus reducing the flexibility and portability of the device, particularly if it is to be used with personal digital assistants (PDAs) or other devices that are usually carried around by users.

What is needed, then, is a system and method for facilitating two or more input modes in a sensory input device. What is further needed is a system and method for facilitating two or more input modes without requiring separate physical space to be designated for each. What is further needed is a system and method for facilitating multiple input modes in a small space and on an inert surface such as a desktop. What is further needed is a system and method for facilitating multiple input modes in a sensory input device without requiring a user to reposition his or her fingers when switching from one mode to another. What is further needed is a system and method for facilitating two or more input modes while preserving the flexibility, portability, and other advantages of a sensory input device.

### SUMMARY OF THE INVENTION

This invention enables two or more input modes (for instance, keyboard and mouse) in an overlapping or coextensive physical space using a sensory input system. The invention is operable on an inert surface such as a desktop. The user moves his or her fingers as though interacting with an ordinary input device; the system of the invention detects the finger motions and interprets them accordingly. Depending on the currently active mode, the invention interprets the finger motions as input according to one of the input modes, and changes its sensory input interpretation techniques so as to be better adapted to receive and interpret input in the current input mode.

In one embodiment, the user can switch from one mode to another by specifying a mode switch command. In another embodiment, the system of the invention automatically detects, from the nature of the user's input, that the input mode should be switched, and performs the mode switch accordingly. For example, in an embodiment that provides a keyboard mode and a mouse mode, the sensing device of the invention detects whether a user appears to be tapping (as one would interact with a keyboard) or gliding across the work surface (as one would interact with a mouse). Depending on the detected input type, the system of the invention automatically switches to the corresponding input mode and interprets the user's finger motions accordingly.

In one embodiment, the system of the invention projects an input guide onto the work surface, so as to help the user in positioning his or her fingers properly. In one embodiment, the invention changes the input guide when the input mode changes, so as to provide a guide that is appropriate to the current input mode. In another embodiment, the projected input guide does not change when the mode changes. In another embodiment, the system of the invention projects input guides for two or more modes simultaneously. In yet another embodiment, the user is able to configure the system regarding whether or not to change, the projected input guide when the mode changes.

The present invention is able to operate in conjunction with any of the various implementations and designs described in the above-referenced related applications. For example, the present invention may be implemented in a device that uses techniques for combining stimuli in multiple sensory domains as described in U.S. patent application Ser. No. 10/187,032 for “Detecting, Classifying, and Interpreting Input Events Based on Stimuli in Multiple Sensory Domains.”

The present invention thus provides many of the advantages of sensory input systems that can operate on an inert surface, and provides the further advantage of being able to accept input in multiple modes within the same physical space. In addition, the present invention is able to change its sensory input interpretation techniques depending on the current mode, so as to more accurately capture and interpret input in different modes. Furthermore, although the description herein is focused primarily on keyboard and mouse input modes, one skilled in the art will recognize that the techniques of the present invention can be applied to any sensory input system offering multiple input modes, and that the input modes can correspond to any type of physical or virtual input mechanism, including for example: musical instruments, joysticks, trackballs, jog/dial controllers, pen-based tablets, and the like.

### BRIEF DESCRIPTION OF THE DRAWINGS

FIG. 1A is a diagram depicting an integrated multiple-mode input device displaying a keyboard guide according to one embodiment of the present invention.

FIG. 1B is a diagram depicting an integrated multiple-mode input device displaying a mouse guide according to one embodiment of the present invention.

FIG. 1C is a diagram depicting an integrated multiple-mode input device displaying a combination keyboard/mouse guide according to one embodiment of the present invention.

FIG. 2 is block diagram of an embodiment of the present invention.

FIG. 3 is an example of a keyboard guide for one embodiment of the present invention.

FIG. 4 is a flowchart depicting a method for providing multiple input modes in an overlapping physical space, according to one embodiment of the present invention.

FIG. 5 is block diagram depicting dispatching events to appropriate event queues, according to one embodiment of the present invention.

FIG. 6 is a diagram depicting a stand-alone multiple-mode input device displaying a keyboard guide according to one embodiment of the present invention.

FIG. 7 is a diagram depicting a stand-alone multiple-mode input device displaying a mouse guide according to one embodiment of the present invention.

FIG. 8 is an example of a use case illustrating key occlusion.

FIG. 9 is another example of a use case illustrating key occlusion.

FIG. 10 is another example of a use case illustrating key occlusion.

The Figures depict preferred embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF A PREFERRED EMBODIMENT

The following description of system components and operation is merely exemplary of embodiments of the present invention. One skilled in the art will recognize that the various designs, implementations, and techniques described herein may be used alone or in any combination, and that many modifications and equivalent arrangements can be used. Accordingly, the following description is presented for purposes of illustration, and is not intended to limit the invention to the precise forms disclosed.

Architecture

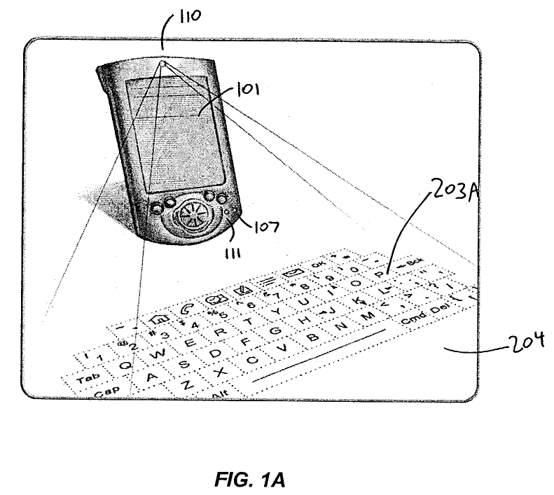

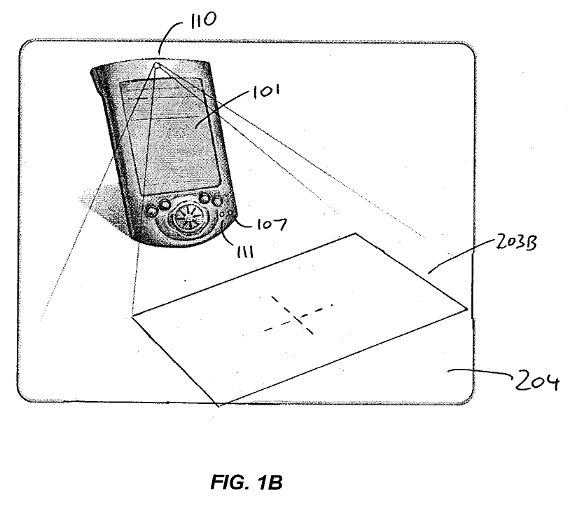

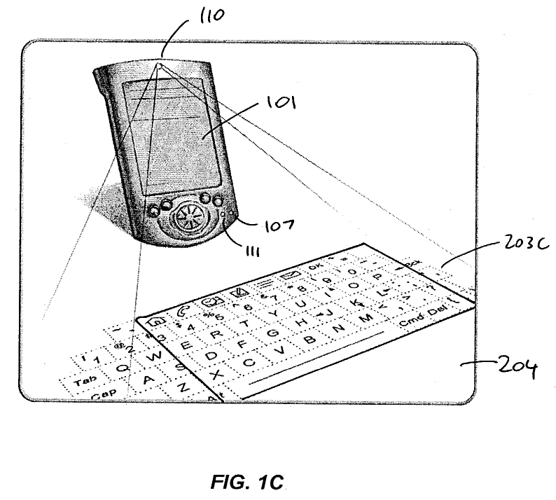

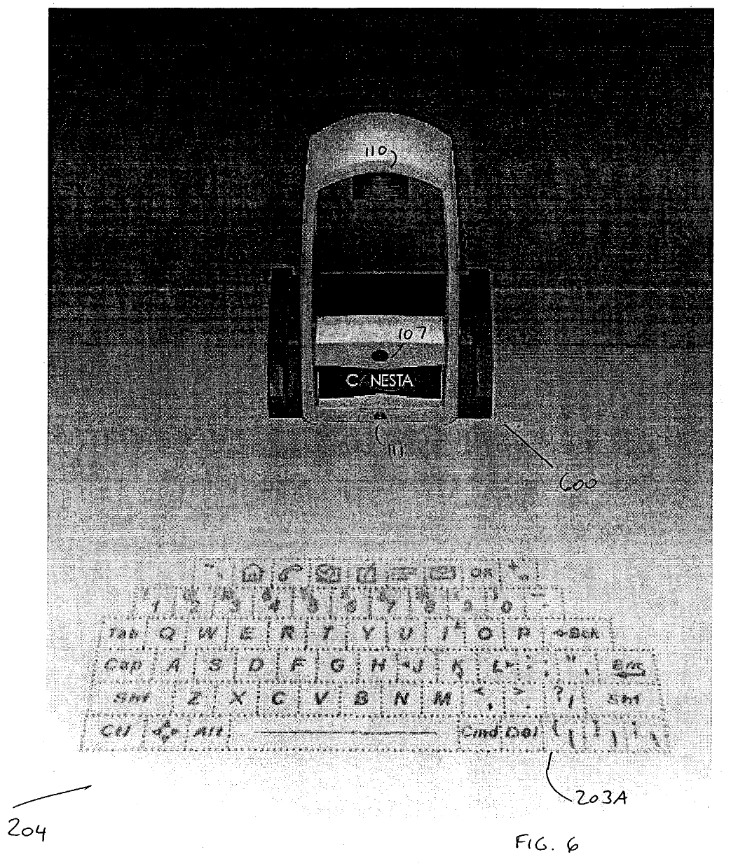

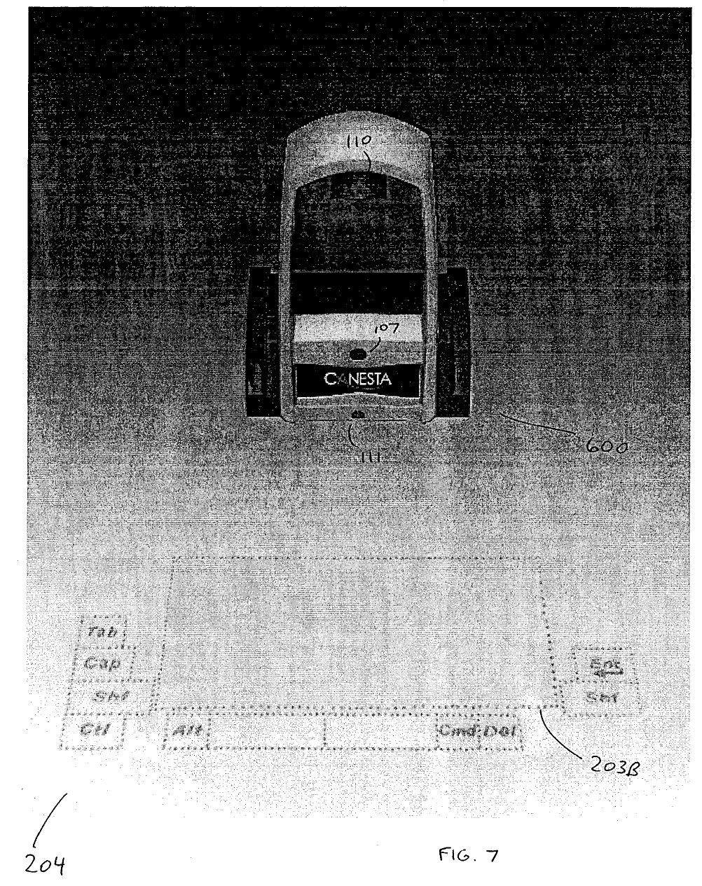

Referring now to FIGS. 1A through 1C, there is shown a diagram of an integrated device 101 that includes apparatus for providing input functionality according to one embodiment of the present invention. Referring also to FIGS. 6 and 7, there is shown a diagram of a stand-alone device housing 600 that includes apparatus for providing input functionality according to one embodiment of the present invention. In general, the present invention operates to provide input for any type of device 101, which may be a personal digital assistant (PDA), cell phone, or the like. The invention may be implemented in an apparatus enclosed within device 101 (as shown in FIGS. 1A through 1C) or in a separate housing 600 (as shown in FIGS. 6 and 7) that includes apparatus for sending input signals to a host device. In one embodiment, the present invention provides mechanisms for implementing data input methods, modes, and apparatuses including direct three-dimensional sensing, planar range sensors, and vertical triangulation. Such techniques detect user input by sensing three-dimensional data to localize the user's fingers as they come in contact with surface 204. In one embodiment, surface 204 is an inert work surface, such as an ordinary desktop.

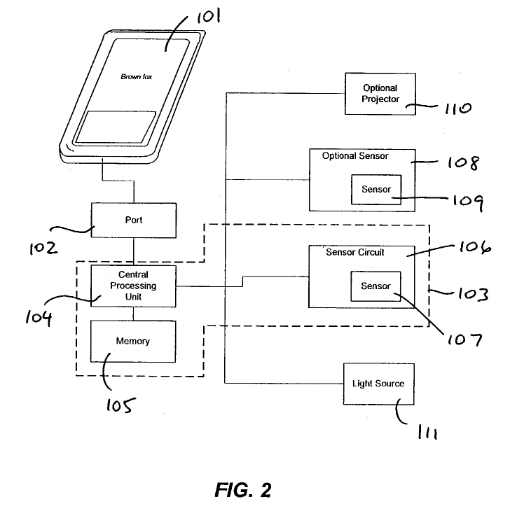

Referring also to FIG. 2, there is shown a block diagram depicting an input device according to an embodiment of the present invention. In one embodiment, one or two (or more) sensor circuits 106, 108 are provided, each including a sensor 107, 109. Sensors 107, 109 may be implemented, for example, using charge-coupled device (CCD) and/or complementary metal-oxide semiconductor (CMOS) digital cameras as described in U.S. Pat. No. 6,323,942, to obtain three-dimensional image information. While many of the embodiments shown herein include one sensor 107, one skilled in the art will recognize that any number of sensors can be used, and thus references to “a sensor” are understood to include multiple sensor embodiments. It is beneficial, in some embodiments using three-dimensional sensing technology, to position sensors 107, 109 at the bottom of device 101, so as to more accurately detect finger motions and contact with the work surface in the proximity of the bottom of such device. Alternatively, it may be preferable in some embodiments to position sensors 107, 109 at the side and towards the center or above device 101. Such a location may be advantageous to provide an improved vantage point relative to the location of the user's fingers on the work surface when using two-dimensional sensors such as CCD or CMOS cameras.

Central processing unit (CPU) 104 runs software stored in memory 105 to detect input events, and to communicate such events to an application running on host device 101. In implementations where the input device of the present invention is provided in a separate housing 600 from host device 101 (as shown in FIGS. 6 and 7), CPU 104 communicates with device 101 via any known port 102 or communication interface, such as for example serial cable, Universal Serial Bus (USB) cable, Infrared Data Association (irDA) port, Bluetooth port, or the like. Light source 111 illuminates the area of interest on the work surface so that sensors 107, 109 can detect activity.

In one embodiment, sensor circuit 106, sensor 107, memory 105, and CPU 104, as well as circuitries for controlling optional projector 110 and light source 111, are integrated into a single CMOS chip or multi-chip module 103, also referred to as a sensor subsystem 103. One skilled in the art will recognize that in alternative embodiments the various components of module 103 may be implemented separately from one another.

In one embodiment, projector 110 projects an input guide (shown variously as 203A, 203B, and 203C in the drawings) onto work surface 204. Guide 203A, 203B, 203C has a virtual layout that mimics the layout of a physical input device appropriate to the type of input being detected. For example, in FIG. 1A and FIG. 6, guide 203A has a layout resembling a standard QWERTY keyboard for entering text. In the examples of FIG. 1B and FIG. 7, mouse input guide 203B is projected, to show the user the active area for virtual mouse movement. In the example of FIG. 1C, a combination keyboard/mouse input guide 203C is projected, drawn as a mouse guide overlaying a keyboard guide. In one embodiment, whenever a combination keyboard/mouse input guide 203C is projected, the mouse guide is projected in a different color than the keyboard guide, to further clarify the distinction between the two. Guide 203C indicates that the user can either type or perform mouse movements, in the same area of work surface 204. In one embodiment, as will be described in more detail below, device 110 is able to receive mouse input even when keyboard input guide 203A is projected, and even when no mouse input guide is projected. In general, one skilled in the art will recognize that input guide 203 can take any form appropriate to the currently active input mode.

Multiple Modes

The present invention accepts user input in two or more modes. Two or more input modes can be implemented in a sensing device by providing separate detection areas for each input mode. Thus, a mouse area and a keyboard area might be defined, possibly having separating sensing apparatus for each. A user wishing to provide mouse input moves his or her fingers within the defined mouse area. When the user wishes to provide keyboard input, he or she moves his or her fingers within the defined keyboard area. In such an implementation, the input mode areas are non-overlapping.

In a preferred embodiment, the detection areas for the input modes overlap one another, at least in part. Such an approach allows each detection area to be made larger, and therefore facilitates input within a relatively small desktop area, without compromising input detection area size. In addition, such an approach reduces or eliminates the requirement that the user move his or her fingers from one physical area to another when switching between input modes. In one embodiment, one detection area wholly includes or is coextensive with another detection area, so that the user can keep his or her fingers in the same physical area even when the device switches from one input mode to another.

For illustrative purposes, in the following description the invention will be described in terms of keyboard and mouse input modes. However, one skilled in the art will recognize that the techniques of the present invention can be used to implement other input modes in any combination. Thus, the invention is not intended to be limited to the particular example of a keyboard mode and a mouse mode.

When in a keyboard mode, device 101 interprets the user's finger motions as keyboard input. Based on sensor 107 detection of the user's finger positions at the time the user taps on work surface 204, device 101 determines which keystroke was intended.

When in a mouse mode, device 101 interprets the user's finger motions as though it were input from a pointing device such as a mouse, trackball, trackpad, or the like. Based on sensor 107 detection of the user's finger positions and movements on work surface 204, device 101 moves an onscreen cursor, activates onscreen objects, highlights onscreen text and objects, and performs other activities commonly associated with and controlled by pointing devices such as mice.

When in other input modes, device 101 interprets the user's finger motions in a manner appropriate to the currently active mode.

In one embodiment, device 101 switches from one mode to another in response to a command from the user. The user may request a mode switch by pressing a designated button on device 101, or by performing a predefined gesture or finger movement detected by sensor 107 and interpreted by device 101, or by speaking, tapping, or issuing some other auditory command that is detected and interpreted by device 101 according to conventional voice recognition or auditory recognition techniques. In one embodiment, a number of different mechanisms for commanding a mode switch may be provided, allowing the user to select the mechanism that is most convenient at any given time. Recognizing that users often switch rapidly and repeatedly from one mode to another, the present invention makes it very easy and convenient to perform such switches.

Additional examples of mode change mechanisms and commands include, without limitation:

Pressing a designated virtual key or keys changes into a new mode until the same key is pressed again.

Pressing a designated virtual key or keys changes into a new mode only while the key or keys are depressed.

Pressing a specific sequence of virtual keys (e.g. Ctrl-Shift-1) changes into a new mode.

Specific finger movements change mode. For example, a double tap on work surface 204 enters a mode, and triple tap exits a mode. Since a sensing system is being used, the finger movements are not limited to traditional computing finger movements. New operations such as a “pinch,” “flick,” “wiggle,” “scrub,” or other type of defined finger movement could also change modes.

One skilled in the art will recognize that the above list is merely exemplary, and that many other techniques for providing and interpreting mode change commands can be used without departing from the essential characteristics of the invention. In addition, node change commands (and other commands) need not be limited to movement along work surface 204. Gestures or other body movements could be used to change modes in a 3-dimensional environment. For instance, a thumbs-up or thumbs-down gesture could enter and/or exit a mode. Making a fist could change mode, grasping hands together could change mode, and so on. Kicking a leg or shaking hips could also change mode.

In another embodiment, device 101 automatically switches from one mode to another depending on the current context of the user interaction, or under control of the host device. For example, a numeric virtual keyboard mode can be activated when the context of the user interaction dictates that numeric input is expected.

In another embodiment, device 101 automatically switches from one mode to another, based on the nature of the detected finger positions and motions of the user. For example, if sensor 107 detects that the user has his or her fingers in a typing position or is moving his or her fingers in a manner consistent with typing, device 101 automatically switches to keyboard mode, and interprets finger movements as keystrokes. If sensor 107 detects that the user is gliding his fingers along surface 204 in a manner consistent with moving a mouse or interacting with a trackpad, device 101 automatically switches to mouse mode, and interprets finger movements as mouse movements.

In one embodiment, keyboard and mouse input are distinguished from one another by analysis of finger image blob motion. Blob motion representing keyboard input tends to be essentially vertical, corresponding to the tapping of keys, so that when the device detects a quick descent followed by an abrupt stop, it can assume keyboard input. By contrast, blob motion representing mouse input tends to have small amounts of vertical motion; thus, when the device detects movement parallel to the plane of the work surface with minimal vertical movement, it can assume mouse input.

In one embodiment, even if automatic mode switches are provided, device 101 allows the user to temporarily disable and/or override automatic mode switches. Thus, in the event the user's finger movements cause device 101 to make incorrect assumptions regarding the input mode, or if the user's current activity is specialized or limited to one mode, the user is able to control the manner in which his or her actions are interpreted.

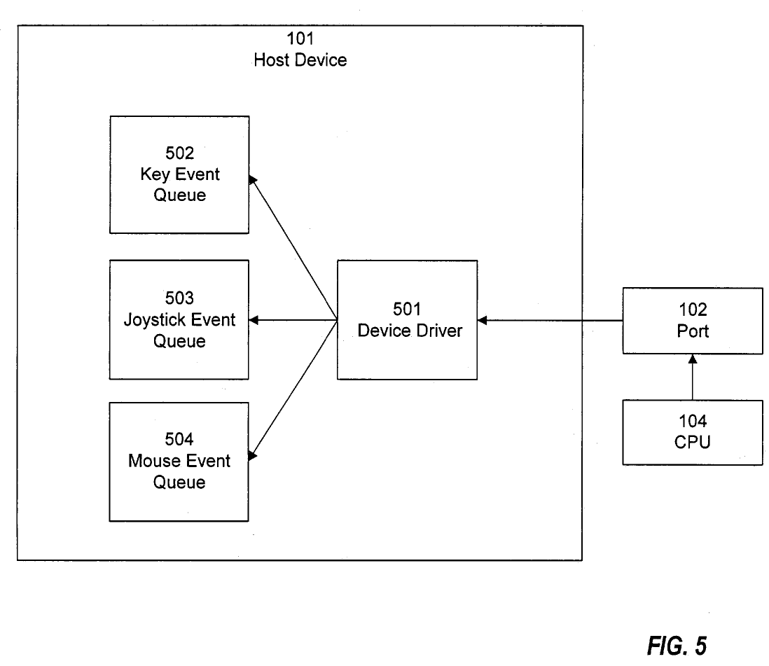

In one embodiment, the invention provides seamless integration of the multiple mode sensory input system with an existing host system such as a personal computer or standalone PDA. Referring again to FIG. 2 and also to FIG. 5, CPU 104 communicates, via port 102, with a device driver 501 on device 101 that interprets the incoming events (such as keystrokes, joystick action, or mouse movements) and dispatches those events to an appropriate standard event queue 502-504 for those “virtual” devices. For instance, the keystrokes are dispatched to key event queue 502, the joystick actions to joystick event queue 503, and the mouse events to mouse event queue 504. Once the events are in the appropriate queue, device 101 processes the events as if they were coming from an actual physical device (such as a physical keyboard, joystick, or mouse). The invention thereby facilitates “plug-and-play” operation in connection with applications already written for the supported device types (such as keyboard, joystick, or mouse). In some embodiments, event queue 502-504 is implemented as another device driver or is embedded inside another device driver. In this case, the invention manipulates the other device drivers to insert the events in the driver directly.

This device driver system does not limit the functionality to compatibility with old applications, however. New applications that can support a more rich or enhanced set of event information are also support by dispatching this more rich set of event information directly to them. The invention thereby works with existing legacy applications, but also supports new applications with additional functionality.

Input Guide

As described above, and as depicted in FIGS. 1A through 1C, 6, and 7, in one embodiment device 101 includes projector 110 for projecting input guide 203 onto work surface 204. Input guide 203 is not an essential element of the invention, and in some embodiments the user provides input by moving his or her fingers on work surface 204 without the need for any input guide 203. For example, if the user is controlling the movement of an onscreen cursor in a mouse mode, the user is generally able to provide accurate input without any input guide 203. Accordingly, in some embodiments, input guide 203 may be switched on or off by the user, by activating a command, or input guide 203 may switch on or off automatically depending on which input mode is active. In other embodiments, projector 110 may be omitted without departing from the essential characteristics of the invention.

In embodiments that do include one or more input guides 203, projector 110 may project a different input guide 203 for each mode. Thus, the particular input guide 203 being projected depends on and is appropriate to the current input mode. If the currently active mode is a keyboard mode, projector 110 projects a keyboard guide 203A, as depicted in FIGS. 1A and 6. If the currently active mode is a mouse mode, projector 110 projects a mouse guide 203B, as depicted in FIGS. 1B and 7. Projector 110 switches from one guide to another in response to input mode changes.

Alternatively, in another embodiment projector 110 does not switch guides 203 automatically. Users may find repeated guide-switching distracting. Accordingly, in one embodiment, input guide 203 for a first input mode (e.g. keyboard mode) continues to be projected even when device 101 switches to a second input mode (e.g. mouse mode). In another embodiment, input guide 203 is projected as the superposition of input guides 203 for two or more input modes. For example, in FIG. 1C, input guide 203C is the superposition of a keyboard input guide and a mouse input guide. For clarity, in one embodiment, the two input guides being superimposed are projected in different colors, or are otherwise rendered visually distinct from one another.

In some embodiments, any or all of the above-described input guide 203 projection schemes are user-configurable. Thus, for example, device 101 may provide configuration options allowing a user to specify whether, and under which conditions, a particular type of input guide 203 is projected at any given time.

In yet other embodiments, some or all of the guides described above are printed on a flat surface (such as a piece of paper), rather than or in addition to being projected by projector 110.

In yet other embodiments, one or more three-dimensional guides may be used. A three-dimensional guide could be implemented as a two-dimensional drawing of a three-dimensional action that accomplishes a mode-change (or performs some other action) or it could, in fact, be a three-dimensional image projected, for example, as a hologram.

Method of Operation

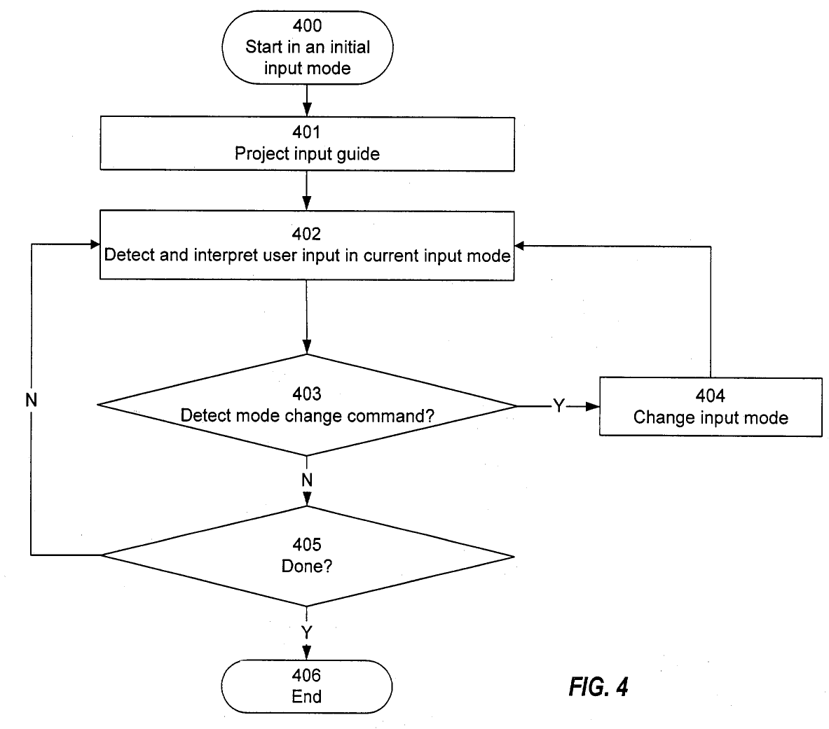

Referring now to FIG. 4, there is shown a flowchart depicting a method of providing multiple input modes in the same physical space according to one embodiment of the invention.

Device 101 starts 400 in one of the input modes (for example, it may start in the keyboard mode). An appropriate input guide 203 is projected 401. The user provides input via finger movements on work surface 204 (for example, by typing on virtual keys), and device 101 detects and interprets 402 the finger movements using techniques described in the above-referenced related patent applications.

Device 101 detects 403 a mode-change command, which instructs device 101 to change to another input mode. As described above, in some embodiments, a mode-change command is not needed, and device 101 can change modes automatically depending on the nature of the detected input.

Device 101 then changes input mode 404 so that it now detects movements corresponding to the new mode. For example, if the user indicated that he or she is about to start performing mouse input, device 101 would change to a mouse input mode. In one embodiment, the input modes are implemented using lookup tables defining each layout and multiple-state machines.

If additional mode changes are specified, steps 402 through 404 are repeated. Otherwise, if the user is done with input 405, the method ends 406.

### EXAMPLE

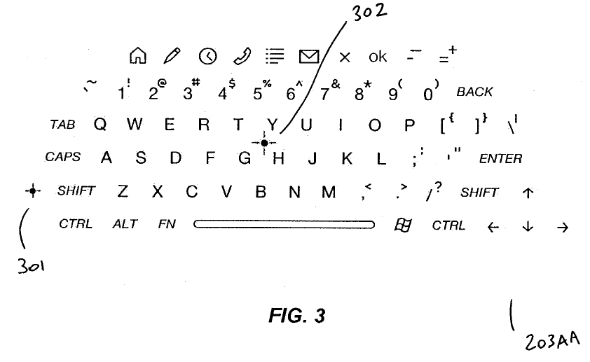

Referring now to FIG. 3, there is shown an example of a keyboard guide 203AA, that projector 110 projects onto an inert work surface 204 according to one embodiment, and that facilitates both a keyboard mode and a mouse mode.

Sensors 107, 109 detect the user's finger movements with respect to the virtual keys shown in the keyboard guide 203AA. As described in related applications cross-referenced above, sensors 107, 109 detect user contact with the virtual keys, and device 101 interprets the contact as a keystroke.

The user touches cross-hair 301 to switch to a mouse input mode. In one embodiment, some indication of mouse input mode is presented, for example by altering the color, brightness, or other characteristic of keyboard guide 203AA. The user places a finger on cross-hair 302 and moves his or her finger around to control an on-screen cursor. Sensors 107, 109 detect the x-y coordinates of the touch point as the user moves his or her finger around. Device 101 interprets these coordinates as mouse movement commands, and can further detect and interpret common mouse behaviors such as acceleration, clicking, double-clicking, and the like.

Changing Sensory Input Interpretation Techniques According to Mode

In one embodiment, the present invention changes its sensory input interpretation techniques depending on the current mode, so as to more accurately capture and interpret input in different modes. For example, the device may use different sensory input techniques for detecting mouse input, as opposed to detecting keyboard input. Mouse input movement differs from keyboard input movement. For example, keyboard input tends to include tapping movements that are perpendicular to the work surface; mouse input tends to include movement in the plane of the mouse pad.

Events associated with a mouse are different from keyboard events as well. While the mouse buttons are processed similarly to keyboard keys, the mouse pointer (or other pointing device) has no up or down event; it either rolls on the surface, or it does not. Lifting a mouse or leaving it in place has approximately the same effect. In addition, the main output from a mouse device driver is a sequence of coordinate pairs (plus button events), while keyboard output generally includes key identifiers corresponding to the struck keys. Finally, users often wish to shift the position of the mouse without moving the on-screen cursor, an operation that is typically done with a physical mouse by lifting the mouse off of the surface and replacing it in a different position; this is referred to as “planing.”

When interpreting keyboard input, the system of the invention determines whether there is contact between a finger and surface 204 either by comparing the height of the finger's image blob against a calibration table of expected blob heights, or by analyzing the blob's motion. As described above, since keyboard motion is essentially vertical, contact can be deemed to have occurred when a blob descends quickly and then stops abruptly.

When interpreting mouse input, as mentioned above, vertical motion tends to be small and unpredictable. Thus, rather than detect abrupt changes in blob descent, the invention uses blob height to distinguish sliding (moving the virtual mouse with the intention of providing input) from planing (adjusting the position of the virtual mouse without intending to provide input). Furthermore, as a finger slides on the pad, the height of its image blob can change as a result of rather unpredictable factors, such as variations in the tilt and orientation of the finger, and in the pressure it exerts on the pad, which in turn causes the fingertip to deform.

In one embodiment, the system of the invention establishes thresholds that are used to determine whether the user intends to glide or plane. If the user's fingers are above a certain threshold height, the motion is considered to be a plane, and the onscreen cursor is not moved. If the user's fingers are below the threshold height, the motion is considered to be a glide, and the onscreen cursor is moved accordingly.

In one embodiment, two thresholds are defined, one for contact and one for release. The release threshold is smaller than the contact threshold. When a finger first appears, the height of its image blob must exceed the contact threshold before contact is declared. Contact is terminated when the blob height goes below the release threshold. This hysteresis confers some stability to the discrimination between sliding and planing.

Key Occlusions

As described above, in one embodiment the device of the present invention changes modes in response to a user's finger movement specifying a mode change command. In some situations, the finger movement specifying a mode change command may be obscured from the view of sensor 107. For example, it is often the case that one of the user's fingers obscures another finger. In one embodiment, upon detection of an up-event (keystroke release) the present invention delays the up-event for a key for a certain number of frames. If after the predetermined number of frames have passed, sensor 107 still detects the finger in the down position, the up-event is discarded; the assumption is made that the up-event was merely the result of an occlusion. If the finger is in the up position after the predetermined number of frames has passed, the up-event is passed to the application.

One skilled in the art will recognize that finger occlusion may take place in connection with any finger movements, and is not limited to mode change commands. Thus, the following discussion is applicable to any user input, and is not restricted in applicability to mode change commands.

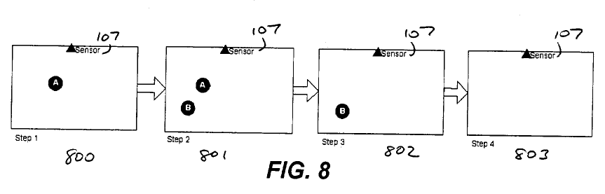

Referring now to FIGS. 8 through 10, there are shown additional examples of occlusion. The following description sets forth a technique for handling these occlusion situations according to one embodiment of the invention.

In FIG. 8, Finger A descends 800, and then Finger B descends behind finger A 801. Finger B becomes visible when finger A ascends 802. Finger B then ascends 803. Since Finger B is occluded by Finger A, sensor 107 does not detect the keypress represented by Finger B until Finger A has ascended in 802. The system therefore recognizes a down event in 802 rather than in 801. In one embodiment, the system transmits the down event to host device 101 two frames after Finger A has ascended in 802.

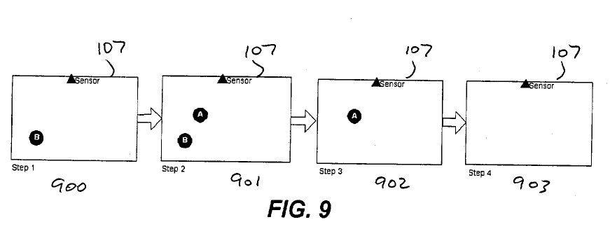

In FIG. 9, Finger B descends 900, and then Finger A moves in front of finger B 901. Finger B ascends while Finger A stays down 902, and then Finger A ascends 903. Since sensor 107 cannot detect Finger B's ascent in 902, an up event for Finger B is recognized in 903 rather than in 902.

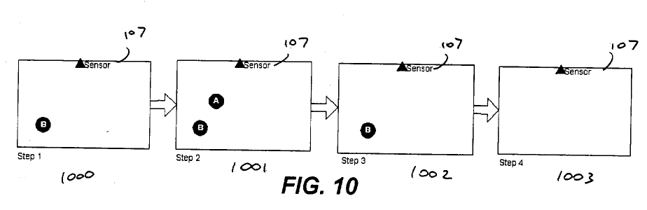

In FIG. 10, Finger B descends 1000, and then Finger A moves in front of finger B 1001. Finger A ascends while Finger B stays down 1002, and then Finger B ascends 1003. This case should behave exactly as a mechanical keyboard.

Other Applications

The above descriptions sets for the invention as applied to keyboard and mouse input modes. One skilled in the art will recognize that other virtual input device combinations can be implemented using the present invention. Examples of such virtual input device combinations include, without limitation:

Keyboard/gesture-editing facilities. A virtual keyboard is used to type characters and then a secondary function is implemented to allow editing using finger or hand gestures.

Musical instruments. A virtual electronic piano or other instrument could be created that allows users to play musical notes as well as different percussion instruments (such as percussion instruments) within the same area of work surface 204.

Video Games. Enabling different functions within the same physical area can optimize Videogames. For instance, one set of functions causes a missile to be fired, while a second set of functions causes a bomb to be dropped.

Point-of-sale terminals. A keyboard is used to enter data specific to a product (for instance, push a button to purchase a product) while a secondary function could be used to enter a name to track the order. Depending on context, the input mode would change from being a general keyboard to a product-specific one.

Context-sensitive input device. Input mode can be changed depending on the context of the interaction, or under host system control or instruction. For example, a numeric virtual keyboard mode can be activated when the context of the user interaction dictates that numeric input is expected.

Automotive applications. A set of gestures (for example, thumbs-up and thumbs-down) may be used to turn the radio up and down in the car. Another set of gestures (for example, point upwards and point downwards) may be used to turn the air-conditioning up and down.

In the above description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

As will be understood by those familiar with the art, the invention may be embodied in other specific forms without departing from the spirit or essential characteristics thereof. For example, the particular architectures depicted above are merely exemplary of one implementation of the present invention. The functional elements and method steps described above are provided as illustrative examples of one technique for implementing the invention; one skilled in the art will recognize that many other implementations are possible without departing from the present invention as recited in the claims. Likewise, the particular capitalization or naming of the modules, protocols, features, attributes, or any other aspect is not mandatory or significant, and the mechanisms that implement the invention or its features may have different names or formats. In addition, the present invention may be implemented as a method, process, user interface, computer program product, system, apparatus, or any combination thereof. Accordingly, the disclosure of the present invention is intended to be illustrative, but not limiting, of the scope of the invention, which is set forth in the following claims.

What is claimed is:

1. An input device having for detecting user input in at least two input modes, comprising:
a sensor, for:
responsive to the input device being in a first input mode, detecting user movement on or proximate to an inert surface within a first physical space, and generating a signal responsive to the detected movement; and
responsive to the input device being in a second input mode, detecting user movement on or proximate to an inert surface within a second physical space, and generating a signal responsive to the detected movement; and
a processor, coupled to the sensor, for:
responsive to the input device being in the first input mode, receiving and processing the detected signal according to the first input mode; and
responsive to the input device being in the second input mode, receiving and processing the detected signal according to the second input mode;
wherein at least a portion of the second physical space overlaps at least a portion of the first physical space.

2. The input device of claim 1, wherein the first input mode is a keyboard mode and the second input mode is a mouse input mode.

3. The input device of claim 1, wherein the second physical space is coextensive with the first physical space.

4. The input device of claim 1, further comprising:
a mode controller, coupled to the processor, for switching from one of the input modes to another of the input modes.

5. The input device of claim 1, wherein:
the processor switches from one of the input modes to another of the input modes.

6. The input device of claim 1, further comprising:
a mode controller, coupled to the processor, for, responsive to a user command, switching from one of the input modes to another of the input modes.

7. The input device of claim 1, wherein:
responsive to a user command, the processor switches from one of the input modes to another of the input modes.

8. The input device of claim 1, further comprising:
a mode controller, coupled to the sensor, for, responsive to at least one characteristic of the detected finger movement, automatically switching from one of the input modes to another of the input modes.

9. The input device of claim 1, wherein:
responsive to at least one characteristic of the detected finger movement, the processor automatically switches from one of the input modes to another of the input modes.

10. The input device of claim 1, further comprising:
a projector, for projecting an input guide adapted to assist the user in providing input according to at least one of the input modes.

11. The input device of claim 1, further comprising:
a projector, for:
responsive to the input device being in the first input mode, projecting an input guide adapted to assist the user in providing input according to the first input mode; and
responsive to the input device being in the second input mode, projecting an input guide adapted to assist the user in providing input according to the second input mode.

12. The input device of claim 1, further comprising:
a projector, for simultaneously projecting at least two input guides adapted to assist the user in providing input according to at least two of the input modes.

13. The input device of claim 12, wherein the projector projects each input guide in a different color.

14. A method for detecting user input in at least two input modes, comprising:
responsive to the input device being in a first input mode:
detecting user movement on or proximate to an inert surface within a first physical space;
generating a signal responsive to the detected movement; and
processing the detected signal according to a first input mode; and
responsive to the input device being in a second input mode:
detecting user movement on or proximate to an inert surface within a second physical space;
generating a signal responsive to the detected movement; and
processing the detected signal according to a first input mode;
wherein at least a portion of the second physical space overlaps at least a portion of the first physical space.

15. The method of claim 14, wherein the first input mode is a keyboard mode and the second input mode is a mouse input mode.

16. The method of claim 14, wherein the second physical space is coextensive with the first physical space.

17. The method of claim 14, further comprising:
switching from one of the input modes to another of the input modes; and
repeating the detecting, generating, and processing steps.

18. The method of claim 14, further comprising:
receiving a user command indicating a mode switch; responsive to the user command, switching from one of the input modes to another of the input modes; and
repeating the detecting, generating, and processing steps.

19. The method of claim 14, further comprising:
responsive to at least one characteristic of the detected user movement, automatically switching from one of the input modes to another of the input modes; and
repeating the detecting, generating, and processing steps.

20. The method of claim 14, further comprising:
projecting an input guide adapted to assist the user in providing input according to at least one of the input modes.

21. The method of claim 14, further comprising:
responsive to the input device being in the first input mode, projecting an input guide adapted to assist the user in providing input according to the first input mode; and
responsive to the input device being in the second input mode, projecting an input guide adapted to assist the user in providing input according to the second input mode.

22. The method of claim 14, further comprising:
simultaneously projecting at least two input guides adapted to assist the user in providing input according to at least two of the input modes.

23. The method of claim 22, wherein simultaneously projecting at least two input guides comprises projecting each input guide in a different color.
